(19) United States
(12) Patent Application Publication
(10) Pub. No.: US 2025/0037985 A1
(43) Pub. Date: Jan. 30, 2025

(54) AXIAL ION SOURCE WITH MAGNETIC FIELD ADJUSTMENT

(71) Applicant: Thermo Finnigan LLC, San Jose, CA (US)

(72) Inventors: Dustin D. HOLDEN, Round Rock, TX (US); Scott T. QUARMBY, Round Rock, TX (US); George B. GUCKENBERGER, Austin, TX (US)

(21) Appl. No.: 18/360,638

(22) Filed: Jul. 27, 2023

(51) Int. Cl. H01J 49/14; H01J 49/20

(52) U.S. Cl. CPC H01J 49/147; H01J 49/20

(57) ABSTRACT

Systems and methods taught herein generate a non-uniform magnetic field in the ionization region of an ion source to improve robustness in electrical and chemical ionization processes, particularly negative chemical ionization (CI) processes. The non-uniform magnetic field within the ionization volume spatially separates electrons and anions such that anions primarily pass through an ion exit aperture in the ionization chamber while electrons are directed to strike side walls or end walls of the ionization chamber away from the ion exit aperture. As a result, greater numbers of ions exit from the ion source towards a mass analyzer. Systems and methods taught herein also increase the longevity of instrumentation by avoiding damage that can be caused by electrons striking surfaces around apertures.

### BACKGROUND

Mass spectrometry can be used to perform detailed analyses on samples. Furthermore, mass spectrometry can provide both qualitative (is compound X present in the sample) and quantitative (how much of compound X is present in the sample) data for a large number of compounds in a sample. These capabilities have been used for a wide variety of analyses, such as to test for drug use, determine pesticide residues in food, monitor water quality, and the like.

Sensitivity of a mass spectrometer can be limited by the efficiency of the ion source, ion losses in the mass spectrometer and in the mass analyzer, and the sensitivity of the detector. Increasing the efficiency of the ion source (e.g., the number of ions produced per unit sample or per unit time) can significantly improve the detection limits of the mass spectrometer, enabling the detection of lower concentrations of compounds or the use of smaller amounts of sample. Additionally, increasing the stability of the ion source and the number of ions produced as a function of time can improve quantitative comparisons between runs and samples.

### BRIEF SUMMARY

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a mass spectrometry platform in accordance with various embodiments taught herein.

FIG. 2A illustrates a cross-sectional view of an ion source in accordance with various embodiments taught herein.

FIG. 2B illustrates a perspective exploded view of the ion source of FIG. 2A.

FIG. 3A illustrates a simulation of electron trajectories in an ion source when used for positive chemical ionization (CI).

FIG. 3B illustrates a simulation of electron trajectories in the ion source when used for negative CI.

FIG. 4 illustrates an aspect of the subject matter in accordance with one embodiment.

FIG. 5A illustrates a simulation of magnetic field lines for an ion source including only paramagnetic components.

FIG. 5B illustrates a simulation of magnetic field lines and magnetic field strength in the ion source that includes a combination of paramagnetic and ferromagnetic elements in accordance with various embodiments taught herein.

FIG. 6A illustrates a simulation of electron trajectories within the conventional ion source having primarily or only paramagnetic components.

FIG. 6B illustrates a simulation of electron trajectories within the ion source having a combination of paramagnetic components and ferromagnetic components.

FIG. 7A is a photograph of the filament-side face of the ion exit aperture 236 and end wall 234 from a conventional system include only paramagnetic elements.

FIG. 7B is a photograph of the filament-side face of the ion exit aperture 236 and end wall 234 from an ion source including both paramagnetic elements and ferromagnetic elements 242 as taught herein.

FIG. 8A illustrates a simulated x-y plot of the distribution of electron locations in the plane of the ion exit aperture for the conventional source with only paramagnetic components.

FIG. 8B illustrates a simulated x-y plot of the distribution of electron locations in the plane of the ion exit aperture for the ion source with a combination of paramagnetic components and ferromagnetic elements 242 in accordance with embodiments taught herein.

FIG. 9A illustrates a simulated z-0 plot of the distribution of electron locations along the inner surface (i.e., bore) of a conventional ionization chamber.

FIG. 9B illustrates a simulated z-0 plot of the distribution of electron locations along the inner surface (i.e., bore) of the ionization chamber for an ion source having a combination of paramagnetic elements and ferromagnetic elements 242 in accordance with embodiments taught herein.

FIG. 10 shows several plots related to magnetic field as a function of distance from the magnetic field generator for a variety of sources.

FIG. 11A illustrates a simulation of magnetic field lines for a conventional ion source including only paramagnetic components.

FIG. 11B illustrates a simulation of magnetic field lines and magnetic field strength in the ion source that includes a combination of paramagnetic and ferromagnetic elements in accordance with various embodiments described herein.

FIG. 12A illustrates a simulation of electron trajectories within the conventional ion source having primarily or only paramagnetic components.

FIG. 12B illustrates a simulation of electron trajectories within the ion source as taught herein wherein a ferromagnetic element 242 is located in the vicinity of the electron lens.

FIG. 13A illustrates a magnified portion of the view in FIG. 12A.

FIG. 13B illustrates a magnified portion of the view in FIG. 12B.

FIG. 14A illustrates a simulated x-y plot of the distribution of electron locations in the plane of the entrance aperture for the conventional source with only paramagnetic components.

FIG. 14B illustrates a simulated x-y plot of the distribution of electron locations in the plane of the entrance aperture for the ion source with a combination of paramagnetic components and ferromagnetic elements in accordance with various embodiments taught herein.

FIG. 15 shows several curves related to magnetic field as a function of distance from the magnetic field generator for a variety of sources.

FIG. 16A illustrates a simulation of magnetic field lines for a conventional ion source including only paramagnetic components.

FIG. 16B illustrates a simulation of magnetic field lines and magnetic field strength in the ion source that includes a combination of paramagnetic and ferromagnetic elements in accordance with various embodiments described herein.

FIG. 17A illustrates a simulation of electron trajectories within the conventional ion source having primarily or only paramagnetic components.

FIG. 17B illustrates a simulation of electron trajectories within the ion source according to embodiments taught herein where the ferromagnetic element is placed in or near the tube lens located after the end wall along the center axis.

FIG. 18A illustrates a simulated x-y plot of the distribution of electron locations in the plane of the ion exit aperture for the conventional source with only paramagnetic components.

FIG. 18B illustrates a simulated x-y plot of the distribution of reflected electron locations on the exit face (i.e., the face opposite the electron source) of the ion exit aperture.

### DETAILED DESCRIPTION

Embodiments of systems and methods for ion sources having improved performance and robustness are described herein and in the accompanying exhibits.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied (unless explicitly noted otherwise) and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to specific temperatures, concentrations, times, pressures, flow rates, cross-sectional areas, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

As used herein, “a” or “an” also may refer to “at least one” or “one or more.” Also, the use of “or” is inclusive, such that the phrase “A or B” is true when “A” is true, “B” is true, or both “A” and “B” are true. Further, unless otherwise required by context, singular terms shall include pluralities and plural terms shall include the singular.

A “system” sets forth a set of components, real or abstract, comprising a whole where each component interacts with or is related to at least one other component within the whole.

In some embodiments, systems and methods taught herein use strategic placement of ferromagnetic elements to generate non-monotonic changes in the magnetic field within the ionization volume of the ionization chamber to improve robustness in chemical ionization processes, particularly negative chemical ionization (CI) processes. In practice, negative CI can have poor robustness due to the challenge of setting up the electrostatic potentials in the ion source to allow analyte anions to pass through the ion source to the analyzer in the presence of electrons. Because anions and electrons have the same polarity, source optics that are attractive or repulsive to anions will also be so for electrons. In the case of an axial source operating in negative CI mode, a beam of electrons may be confined along the center axis of the source. This confined electron beam can create a space charge field. This space charge field affects anion transmission through apertures of the source by repelling anions radially away from the center axis and thus further away from the ion exit aperture through which the ions are intended to pass to exit the source and generate signal at the detector. By employing a non-uniform magnetic field within the ionization volume as taught herein, electrons and anions can be spatially separated such that anions primarily pass through an ion exit aperture in the ionization chamber while electrons are directed to strike side walls or end walls of the ionization chamber away from the ion exit aperture.

Some embodiments of systems and methods taught herein address issues caused by accumulation of electron strikes on surfaces near the ion exit aperture. In particular, systems and methods taught herein improve ion throughput and increase the longevity of instrumentation by avoiding damage that can be caused by electrons striking surfaces around apertures. Electrons with sufficient kinetic energy can interact with species on surfaces of the ion source to form a dielectric layer (sometimes referred to by those skilled in the art as “burn” or “stitch”). Electrons can then impact and reside at the dielectric or burn layer to cause charging that can subsequently repel anions and lead to reductions in transmission of analyte anions through the source. As additional electrons strike this dielectric layer, the surface charges up to the initial potential of the electrons which is typically −70 V. This surface charge repels anions. Another issue caused by burn is that the burned surfaces require periodic cleaning. By using a ferromagnetic element to modify the magnetic field to generate a locally non-monotonic magnetic field within the ionization volume, the disclosed systems and methods reduce burning, which reduces maintenance costs, and reduces the resultant electron accumulation near the ion exit aperture. Moreover, the use of ferromagnetic materials strategically placed in the proximity of the ionization volume can improve negative CI or negative EI processes by reducing burning or stitching of electrons in the vicinity of an ion exit aperture. In conventional ion sources using only paramagnetic materials, electrons strike the end wall around the ion exit aperture resulting in burn. In negative CI or negative EI modes, the accumulated electron charge at the burn repels negative ions thus reducing ion transmission. Embodiments described herein can prevent electrons from burning onto the area around the ion exit aperture to improve ion transmission.

In some embodiments, systems and methods taught herein improve robustness in electron ionization (EI) processes and CI processes by improving injection of electrons into the ionization chamber through an entrance aperture. By introducing a locally increased magnetic field density in the region of the entrance aperture, the electron beam from the filament can be tightened closer to the center axis at the entrance aperture. Consequently, the amount of burning and charging at the entrance aperture is reduced and the flux of electrons through the entrance aperture is increased. Thus, EI and CI processes are enhanced by the presence of a higher number of electrons in the ionization chamber. A reduction in burning also increases longevity of the instrumentation and reduces cleaning or repair requirements.

In some embodiments, systems and methods taught herein can mitigate electron strikes on an exit face of the ion exit aperture by reflected electrons that have exited the ion exit aperture but are turned back by subsequent lens elements. In EI or positive CI processes, a final tube lens in the ion source can be set to repel electrons. Some of the repelled electrons are thereby reflected back towards the source, and a high number of electrons collide with the ion exit aperture on the exit face (i.e., the side facing the exit opposite a side facing the ionization volume) in conventional sources. By employing a non-uniform magnetic field, the reflected electrons can be focused towards the center axis to pass back into the ionization volume through the ion exit aperture and thus avoid striking the exit face of the ion exit aperture. Focusing the electrons to the center axis also increases electron reflection efficiency and increases system robustness by reducing burn intensity at the ion exit aperture.

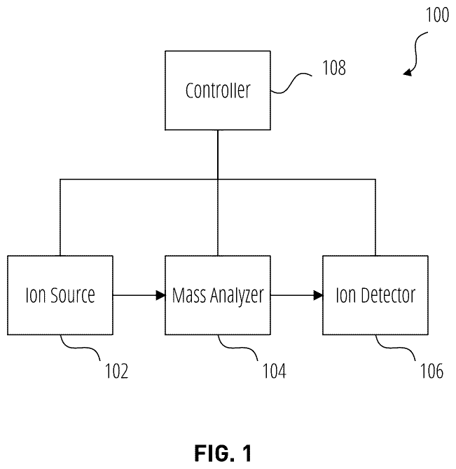

Various embodiments of mass spectrometry platform 100 can include components as displayed in the block diagram of FIG. 1. In various embodiments, elements of FIG. 1 can be incorporated into mass spectrometry platform 100. According to various embodiments, mass spectrometer 100 can include an ion source 102, a mass analyzer 104, an ion detector 106, and a controller 108.

In various embodiments, the ion source 102 generates a plurality of ions from a sample. The ion source 102 can include, but is not limited to, an electron ionization (EI) source, a chemical ionization (CI) source, or both an EI and CI source in combination.

In various embodiments, the mass analyzer 104 can separate ions based on a mass to charge ratio of the ions. For example, the mass analyzer 104 can include a quadrupole mass filter analyzer, a quadrupole ion trap analyzer, a time-of-flight (TOF) analyzer, an electrostatic trap (e.g., ORBITRAP) mass analyzer, Fourier transform ion cyclotron resonance (FT-ICR) mass analyzer, and the like. In various embodiments, the mass analyzer 104 can also be configured to fragment the ions using collision induced dissociation (CID), electron transfer dissociation (ETD), electron capture dissociation (ECD), photo induced dissociation (PID), surface induced dissociation (SID), and the like, and further separate the fragmented ions based on the mass-to-charge ratio.

In various embodiments, the ion detector 106 can detect ions. For example, the ion detector 106 can include an electron multiplier, a photomultiplier, an avalanche diode, a silicon photomultiplier, a Faraday cup, and the like. Ions leaving the mass analyzer can be detected by the ion detector. In various embodiments, the ion detector can be quantitative, such that an accurate count of the ions can be determined. In various embodiments, such as when using an electrostatic mass analyzer, the functions of mass analyzer 104 and ion detector 106 can be performed by the same component.

In various embodiments, the controller 108 can communicate with the ion source 102, the mass analyzer 104, and the ion detector 106. For example, the controller 108 can configure the ion source or enable/disable the ion source. Additionally, the controller 108 can configure the mass analyzer 104 to select a particular mass range to detect. Further, the controller 108 can adjust the sensitivity of the ion detector 106, such as by adjusting the gain. Additionally, the controller 108 can adjust the polarity of the ion detector 106 based on the polarity of the ions being detected. For example, the ion detector 106 can be configured to detect positive ions or be configured to detected negative ions.

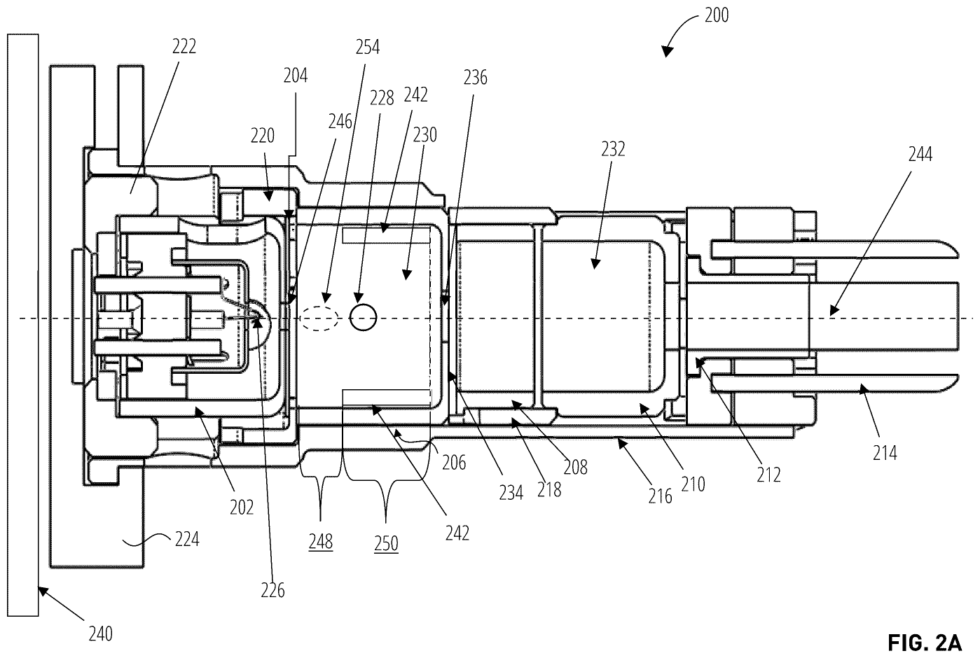

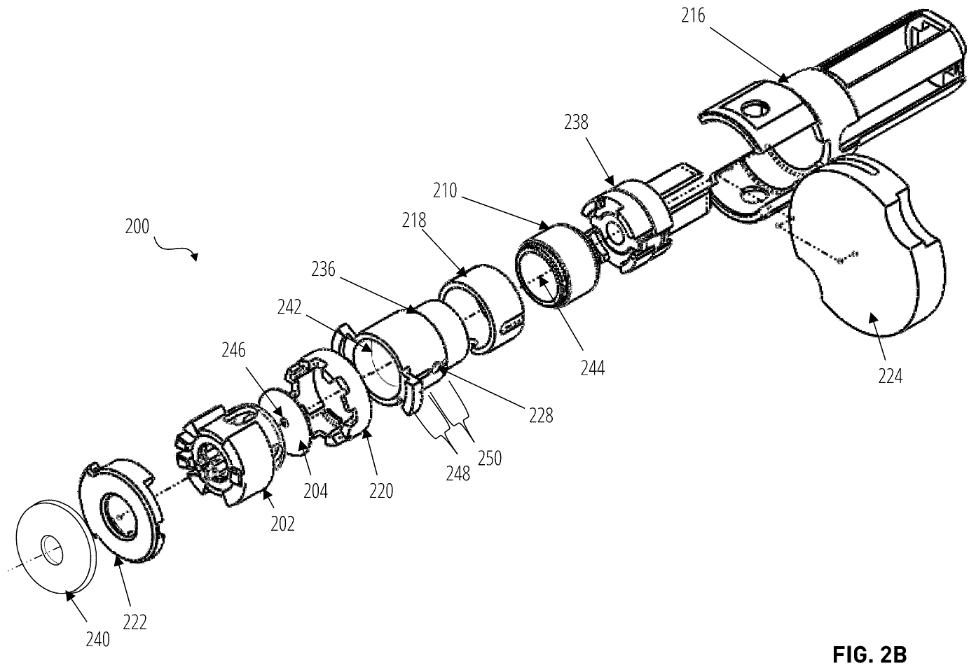

FIG. 2A and FIG. 2B are diagrams illustrating an ion source 200, which can be used as ion source 102 of mass spectrometry platform 100. Ion source 200 can include an electron source 202, an electron lens 204, an ionization chamber 206, lens elements 208, 210, and 212, and RF ion guide 214. Additionally, ion source 200 can include a body 216, insulator 218, spacers 220 and 222, retaining clip 224, one or more ferromagnetic elements 242, and a magnetic field generator 240. In various embodiments, the ionization chamber 206, lens elements 208, 210, and 212, and RF ion guide 214 can be aligned such that ions produced by the ion source form an ion beam. The alignment of the ionization chamber 206, lens elements 208, 210, and 212, and RF ion guide 214 and the direction of the ion beam defines a center axis 244 of the ion source. The positioning of ferromagnetic elements 242 within, around, or outside the ion source adjusts the magnetic field generated by the magnetic field generator 240. In some embodiments, the positioning of the ferromagnetic element 242 can divide the ionization volume 230 into a paramagnetic section 248 and a ferromagnetic section 250. The trajectories of electrons, having low relative mass to analyte ions, will be more affected by changes in the magnetic field, or lack thereof. Because of this, adjustments in the magnetic field along with adjustments in the electrostatic fields within a source can focus, disperse, or steer electron trajectories while minimally affecting analyte ions. For example, in systems and methods described herein, the magnetic field generator 240 and ferromagnetic elements 242 are positioned relative to the ionization chamber 206 to focus electrons closer to the center axis 244 or to defocus or diverge electrons away from the center axis 244 depending upon the particular application.

Electron source 202 can include a thermionic emitter 226 for the generation of electrons. In various embodiments, electron source 202 can include more additional thermionic emitters for redundancy or increased electron production. In alternative embodiments, electron source 202 can include a thermionic filament, a field emitter, electron multiplier, photoelectric effect emitter, or other source of electrons. The electrons can travel axially along ion source 200 through an entrance aperture 246 of an electron lens 204 and into ionization chamber 206 to ionize gas molecules. The electron lens 204 can serve to prevent the ions from traveling back towards the electron source.

Ionization chamber 206 can include gas inlet 228 for directing a gas sample (for example, neutral molecules) into an ionization volume 230 defined by the ionization chamber 206. Gas molecules within the ionization volume 230 can be ionized by the electrons from the thermionic emitter 226. The efficiency of this interaction between neutral molecules and electrons increases as the density of electrons increases, and high electron densities are preferred to ensure sufficient levels of interaction to produce a robust output signal. High densities of electrons can be achieved by confining electrons to the center axis 244 in the paramagnetic section 248. In this context, “confinement” of the electrons means that the magnetic field generated by the magnetic field generator 240 has sufficient strength to restrict motion of electrons away from the center axis 244 of the ionization volume to achieve a target electron density. The confinement of electrons close to the center axis 244 in the paramagnetic section 248 can create a high-density electron region 254 wherein electrons interact with neutral molecules from the gas sample to form ions (e.g., analyte ions in electron ionization or reagent ions in chemical ionization) at a high rate due to the concentration of electrons. In the ferromagnetic section 250, the magnetic field is reduced, and electrons are not well confined to the vicinity of the center axis 248. In other words, the electrons diverge away from the center axis 248 (due, in part, to Coulomb repulsion along with the lower magnetic field) within the ferromagnetic section 250.

Lenses 208 and 210 can define a lens volume 232. Lens volume 232 can include regions of the lenses where some electrons may be present. In various embodiments, it may also include areas outside of the ionization volume and the lenses. End wall 234 can restrict the flow of gas from ionization volume 230 to the lens volume 232, creating a substantial pressure difference between the ionization volume 230 and lens volume 232. In some embodiments, the ferromagnetic element 242 can include the end wall 234. Ion exit aperture 236 can provide a path through end wall 234 for ions to exit the ionization chamber 206.

In various embodiments, the ionization chamber 206 and lens element 208 can be joined to create an extended ionization element defining the ionization volume 230 and at least a portion of the lens volume 232. In such embodiments, lens element 208 can be electrically coupled to ionization chamber 206. In other embodiments, the joined ionization chamber 206 and lens element 208 can be electrically isolated, such that different voltage potentials can be applied to the ionization chamber 206 and the lens element 208.

Lens 210 and 212 and RF ion guide 214 can assist in the axial movement of ions from the ionization volume 230 to additional ion optical elements and mass analyzer 104 of mass spectrometry platform 100. In various embodiments, ion guide assembly 238 can include lens 212 and RF ion guide 214. Ion guide assembly 238 can include additional insulating portions to electrically isolate lens 212 from RF ion guide 214. Additionally, the insulating portions can include standoffs to prevent electrical contact between lens 210 and lens 212.

When assembled into body 216, insulator 218 can prevent electrical contact between lens element 208 and lens element 210. Spacer 220 can prevent electrical contact between electron lens 204 and ionization chamber 206. Spacer 222 can be indexed to prevent rotation of the electron source 202, and retaining clip 224 can hold the other components within body 216.

The ferromagnetic elements 242 can adjust (i.e., increase or decrease) a magnetic field created by the magnetic field generator 240 at localized positions within or near the ionization chamber 206 to control motion of the electrons. The magnetic field generator 240 can include one or more magnetic-field generating sources such as electromagnets and permanent magnetic field generators. While the magnetic field generator 240 is illustrated as being positioned exterior to and at an end of the ion source, one or more magnetic field generators 240 can also be positioned at other locations with respect to the ion source including, for example, outside or inside walls of the ionization chamber 206. For example, magnets located at opposite sides of the ion source can generate a magnetic field that slowly decreases and then starts increasing again across the length of the ionization region. The resulting field produced by one or more magnets is modified by ferromagnetic elements as described in embodiments herein to generate localized and sharp changes in the magnetic field to influence motion of electrons or ions. In some embodiments, the magnetic field generator 240 can be positioned generally at a single radial distance from the center axis 244 and extend along the center axis 244. In the presence of a magnetic field, electrons emitted from thermionic emitter 226 (for example, a heated filament) undergo helical motion perpendicular to the magnetic field lines as the electrons are accelerated and decelerated through the electrostatic field potentials of the source optics (e.g., electron lens 204, lens element 208 lens element 210, lens element 212). By introducing ferromagnetic elements 242 adjacent to one or more lens elements or as part of one or more lens elements, the magnetic permeability becomes dynamic through the source and leads to changes in magnetic flux at different longitudinal locations along the center axis 244.

Ferromagnetic elements 242 can enable reductions in electron collisions with the end wall 234 of ionization chamber 206 and enable reductions in electron outflow through the ion exit aperture 236. With electrostatic potentials set to transmit analyte anions during negative CI analysis, most of the electrons either pass through the source or collide near the ion exit aperture 236 of the ion source 200 (e.g., on the end wall 234). A high density of electron collisions at the end wall 234 near the ion exit aperture 236 increases the rate at which a dielectric layer (i.e., “burning”) is produced, causing charging and repulsion of analyte anions that are intended transmit out through the ion exit aperture 236 to the detector. Similarly, electrons that exit the ionization chamber 206 can collide with other surfaces (and eventually cause charging) that are not as easily cleaned or that are not designed to be cleaned regularly. Both issues can contribute to lack of robustness in negative CI analysis.

The positioning of ferromagnetic elements 242 within, around, or outside the ion source adjusts the magnetic field generated by the magnetic field generator 240. The trajectories of electrons, having low relative mass to analyte ions, will be more affected by changes in the magnetic field, or lack thereof. Because of this, adjusting the magnetic field becomes an additional tool, along with the electrostatic fields within a source, to focus, disperse, or steer electron trajectories, while minimally affecting analyte ions. In particular, the ferromagnetic element can cause spatial separation to occur between a group of ions, which will be less affected by changes in the magnetic field and will tend to stay clustered near the center axis, and a group of electrons, which will be more affected by changes in the magnetic field and will tend to separate away from the center axis.

The ferromagnetic element 242 can be positioned within the ionization chamber. In an example embodiment, the ferromagnetic element 242 can include a cylinder positioned axisymmetrically about the center axis 244. In some embodiments, the ferromagnetic element 242 is permanently or removably affixed or attached to an outer wall of the ionization chamber using fasteners or adhesives. In some embodiments, the ferromagnetic element 242 is retained within the outer wall of the ionization chamber using a friction fit. While the ferromagnetic element is illustrated in FIGS. 2A and 2B as being positioned or disposed within the ionization chamber, alternative positioning of the ferromagnetic element 242 is contemplated. For example, the ferromagnetic element 242 can be embedded directly into the outer wall of the ionization chamber in some embodiments. Alternatively, the outer wall of the ionization chamber can be formed by joining (e.g., welding) end-to-end a length of paramagnetic material and a length of ferromagnetic material.

In other embodiments, the ferromagnetic element 242 can be disposed entirely external to (i.e., outside) the ionization chamber or ionization volume. In some embodiments, the ferromagnetic section 250 can be considered as the volume surrounded by the ferromagnetic element 242, particularly for cylindrical ferromagnetic elements that have an inner bore. In some embodiments, the ferromagnetic element 242 can be configured to move to allow adjustment of the position of the non-uniform magnetic field within or adjacent to the ionization chamber. For example, the ferromagnetic element can include or can be connected to translation aides such as tracks, motors, slides, or other structural features. The translation aide can be manually operated or motorized. In some embodiments, motion of the ferromagnetic element can be controlled by a controller, for example, the controller 108 in FIG. 1 that controls other aspects of the operation of the ion source. In some embodiments, the controller 108 can adjust the position of the ferromagnetic element based upon modeling data, offline feedback, or real-time feedback based upon measured parameters such as ionization efficiency or analyte ion throughput.

Conventionally, paramagnetic materials are used to construct structural elements of the ion source. Paramagnetic materials may include 300 series stainless steels, aluminum and aluminum alloys, certain superalloys such as Inconel (R) (Special Metals Corporation, New Hartford, NY) or Hastelloy (R) (Haynes International, Inc., Kokomo, IN), nichrome (nickel-chromium alloy), titanium, or any other suitable material with a relative magnetic permeability near 1. For purposes of the present disclosure, paramagnetic materials can also include materials considered nonmagnetic such as polymers.

The ferromagnetic element can include ferromagnetic materials. Ferromagnetic materials may include iron, steel, cobalt, nickel, alloys of those metals, Permalloy, mu metal, 400 series stainless steels, or any other materials with a relative magnetic permeability greater than 1.1. It will be understood by one skilled in the art that the ferromagnetic element can include multiple separated or joined ferromagnetic elements or materials and that such a configuration including multiple elements can be referred to as a ferromagnetic section. An additional paramagnetic section may follow the ferromagnetic element of the source. In some embodiments, a surface of the ferromagnetic element 242 can be coated with a different material (e.g., coating) to reduce the chemical reactivity of the surface or make the surface easier to clean. For example, the coating could be applied as an additional layer or by modifying the existing surface layer using chemical vapor deposition, thermal deposition, thermal or electron beam evaporation, or a sputtering process. In some embodiments, a paramagnetic element (such as a form of stainless steel) can be inserted into or around the surface of the ferromagnetic element to block chemical interactions between the constituents of the ionization chamber and the ferromagnetic element. For example, the paramagnetic element can be a foil or thin cylinder insert that lies between the ferromagnetic element 242 and the center axis 244. In some embodiments, the paramagnetic insert can be removable or replaceable when it is dirty thus facilitating permanent mounting of the ferromagnetic element while still keeping the ferromagnetic element surface clean.

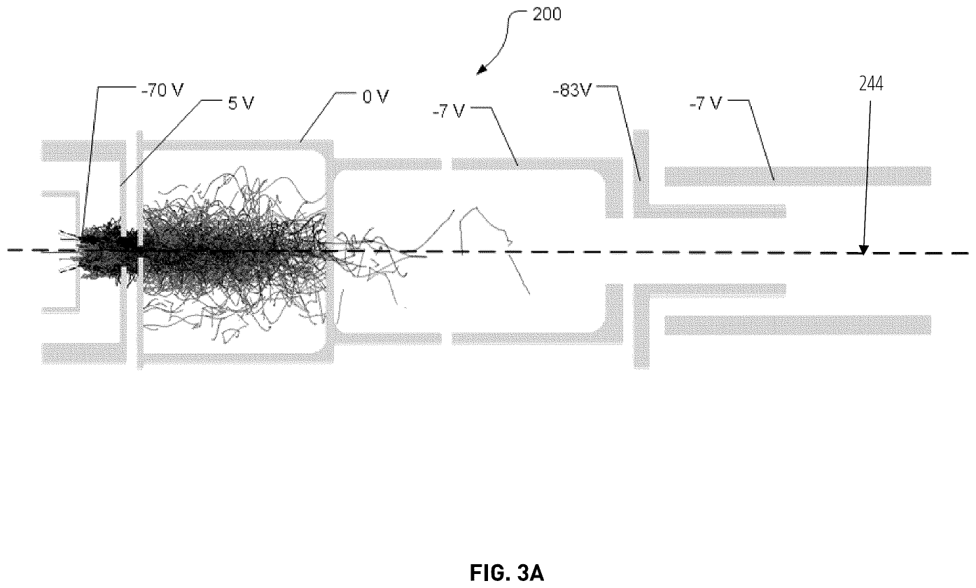

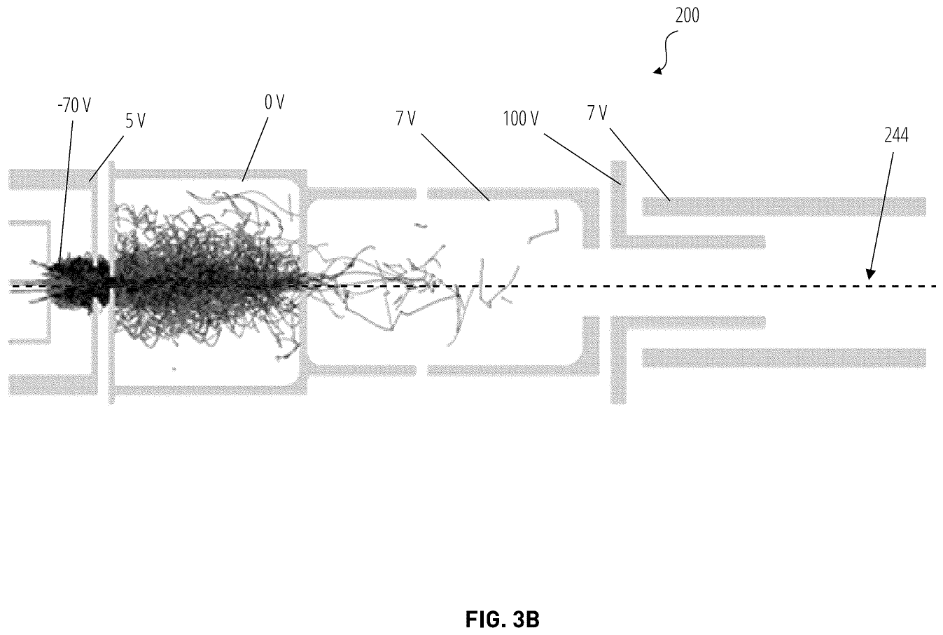

FIG. 3A is an illustration of a simulation of electrons in ion source 200 using positive chemical ionization (CI). Potentials used for the simulation are shown in FIG. 3A and Table 1. In positive CI, the ionizing electrons form reagent ions in the ionization volume. These reagent ions then interact with the analyte neutrals to form positive analyte ions.

TABLE 1
Positive Chemical Ionization

| | Simulation | |
|---|---|---|
| Filament 226 | −70 | V |
| Electron Lens 204 | 5 | V |
| Ionization Chamber 206 | 0 V (grounded) | |
| Lens 208 | 0 V (grounded) | |
| Lens 210 | −7 | V |
| Lens 212 | −83 | V |
| RF Ion Guide 214 | −7 | V |

In ion source 200, electrons can be on center axis 244 with the ion beam. This can have the advantage of using the negative space charge from the electron beam to focus positive ions to the center axis 244. Additionally, a negatively charged ion exit aperture can help extract positive ions. These features can also be beneficial when used for positive CI.

FIG. 3B is an illustration of a simulation of electrons in ion source 200 performing negative CI. Potentials used for the simulation are shown in FIG. 3B and Table 2. In negative CI, the ionizing electrons can form reagent ions in the ionization volume. The outer shell electrons released during this ionization can be at thermal energies. The ionizing electrons can also lose kinetic energy as they collide with the reagent gas. Ultimately, the ionizing electrons can lose kinetic and reach thermal energies. These various thermal energy electrons can then interact with the analyte neutrals and can be captured to produce negative analyte ions.

Electrons striking the area around end wall 234 can result in the accumulation of an insulating layer around the ion exit aperture, changing the potential to close to that of the electrons, −70 V. In various embodiments, neutral molecules from the analyte of matrix can temporarily land on the surfaces of the ionization chamber 206. The molecules will generally leave the surface. However, if electrons strike the neutral molecules while on the surface, they can become attached to the surface in the form of inorganic carbon, silicon dioxide, or other insulating material depending on the composition of the molecule. This can form an insulating layer on the surface of the metal. As charged particles, such as electrons, strike the insulating layer, their charge cannot be quickly dissipated by the underlying metal and instead a charge can accumulate on the insulating layer. Once that occurs, the ion exit aperture can become a barrier to the electrons and the negative ions. This reduces the number of negative ions which leave the ionization volume 230 and travel to the ion detector 106 to be detected.

TABLE 2
Negative Chemical Ionization

| | Simulation | |
|---|---|---|
| Filament 226 | −70 | V |
| Electron Lens 204 | +5 | V |
| Ionization Chamber 206 | 0 V (grounded) | |
| Lens 208 | 0 V (grounded) | |
| Lens 210 | +7 | V |
| Lens 212 | +100 | V |
| RF Ion Guide 214 | +7 | V |

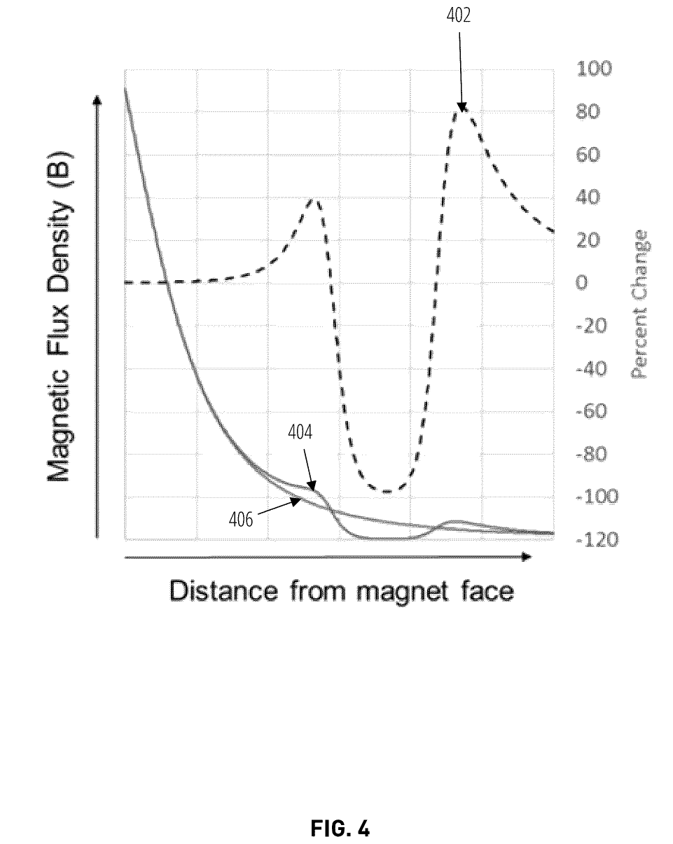

FIG. 4 illustrates magnetic field density curves as a function of distance from the magnetic field generator along the center axis. Curve 406 represents the conventional system with only or primarily paramagnetic components and illustrates an unperturbed magnetic flux density that decreases monotonically with distance from the face of the magnetic field generator.

Curve 404 represents the system as taught herein including a ferromagnetic element. Due to the presence of the ferromagnetic element, the magnetic flux density shown in curve 404 along a length of the ionization volume (e.g., as a function of distance from magnetic field generator 240) is non-monotonic due to sharp fluctuations in density at localized positions along the center axis 244. In the system corresponding to curve 404, an initial section (e.g., paramagnetic section 248) of the ionization chamber is composed of paramagnetic materials, allowing the magnetic field passing through that section of the source, generated by the external magnetic field generator 240 (such as permanent magnetic field generators), to be unaffected. Following the paramagnetic section is the ferromagnetic element that creates a ferromagnetic section 250 and causes the magnetic flux density (B) to sharply and locally increase just before the ferromagnetic element 242 (due to field lines being drawn towards the center axis to preferentially pass through the more permeable ferromagnetic material as opposed to air/vacuum or paramagnetic materials). The magnetic flux density then falls in the center of the ferromagnetic section 250. In this embodiment, following the sharp decrease in magnetic flux density within the ferromagnetic section, the magnetic flux density again increases sharply and locally beyond the ferromagnetic element (again due to field lines having been drawn into the magnetically permeable material). A higher magnetic flux density is achieved upon exiting the material than occurs at the same position absent the ferromagnetic element. For example, this increased magnetic flux density can occur when a second paramagnetic section is disposed after the ferromagnetic section 250 along the center axis 244.

A dashed curve 402 in FIG. 4 illustrates the percentage change in magnetic flux density between curve 404 and curve 406. The curve 402 rises from 0% to around +40% before dropping to a low of −100%. The curve 402 then rises again to a height of about +80% (illustrating the greater magnetic flux density at the exit of the ferromagnetic element) before slowly dropping back towards 0% change. In various embodiments, the ferromagnetic element can cause a percentage change in the magnetic flux density within the ionization volume relative to the same ionization volume absent the ferromagnetic element in a range from 5% to 100%, in a range from 10% to 50%, in a range from 20% to 80%, in a range from 40% to 60%, in a range from 50% to 100%, or any other suitable range. In various embodiments, the ferromagnetic element can cause a percentage change in the magnetic flux density within the ionization volume relative to the same ionization volume absent the ferromagnetic element in a range from −5% and −100%, in a range from −10% to −50%, in a range from −20% to −80%, in a range from −40% to −60%, in a range from −50% to −100%, or any other suitable range.

The trajectories of electrons, which have low mass relative to analyte ions, are affected to a greater degree than ion trajectories by changes in the magnetic field (or lack thereof). Because of this, adjusting the magnetic field becomes an additional tool, along with the electrostatic fields within a source, to focus, disperse, or steer electron trajectories, while minimally affecting analyte ions.

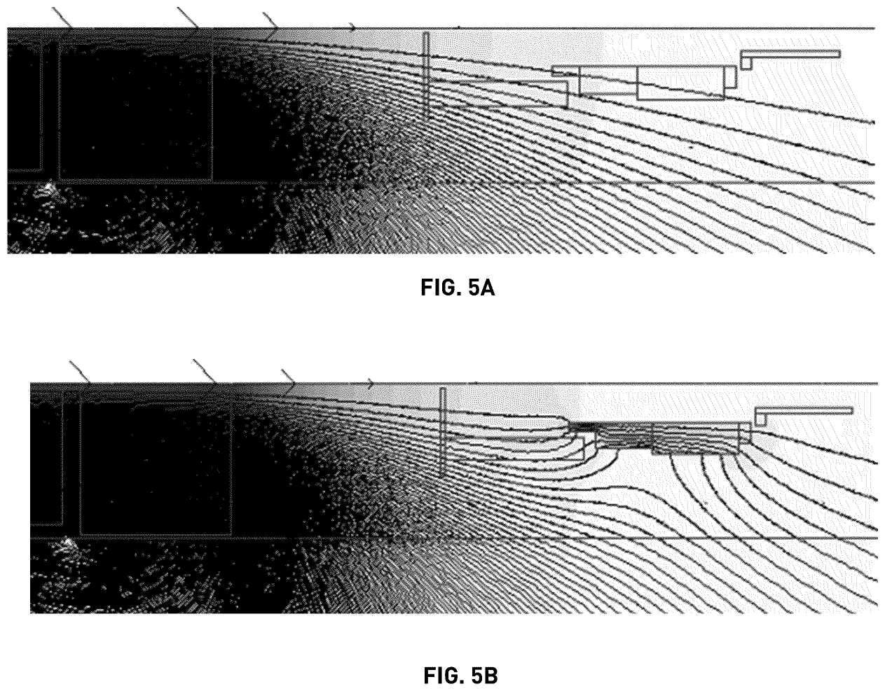

FIG. 5A illustrates a simulation of magnetic field lines for an ion source including only paramagnetic components. To simplify the simulation, the magnetic field generator and ion source are treated as axisymmetric and only the portions on one side of the center axis 244 are drawn. The simulations were conducted using pyFEMM (Python interface to Finite Element Method Magnetics). The magnetic field lines begin at the front face of the magnetic field generator 240 as shown and circle around to end at the opposite face. The field lines pass through components of the ion source with little to no diversion or bending. Additionally, field strength as represented by the background shading in FIG. 5A is uniform throughout the components of the ion source and shows no concentration within or near any components of the ion source.

FIG. 5B illustrates a simulation of magnetic field lines and magnetic field strength in the ion source 102, 200 that includes a combination of paramagnetic and ferromagnetic elements in accordance with various embodiments taught herein. The field lines are deviated slightly in this figure as compared to FIG. 5A. Moreover, the field strength in the ferromagnetic elements 242 of the ion source is retained to a greater degree than in the same elements of FIG. 5A formed from paramagnetic material.

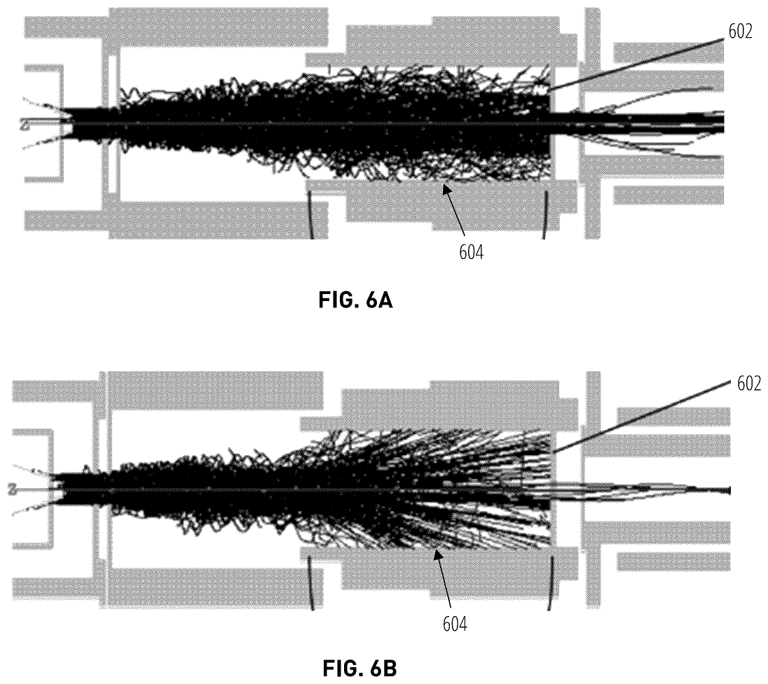

FIG. 6A illustrates a simulation of electron trajectories within the conventional ion source having primarily or only paramagnetic components. An inner surface 604 and the ion exit aperture 602 are indicated. The electron trajectories are computed using SIMION® (Scientific Instrument Services) including the axisymmetric magnetic fields imported from pyFEMM. In these calculations, the electrostatic lens potentials remained the same for comparison among different configurations, and only the magnetic fields varied among the simulations. Unsurprisingly, the trajectories of the electrons tend to be parallel to the center axis 244 as the electron motion is confined by the magnetic field. The accumulation of electrons at the center axis introduces space charge that can repel anions away from the center axis. As a result, repelled anions are less likely to be in a position to pass through the ion exit aperture. Additionally, a large proportion of electrons strike the end wall surrounding the ion exit aperture.

FIG. 6B illustrates a simulation of electron trajectories within the ion source having a combination of paramagnetic components and ferromagnetic components. The inner surface 604 and the ion exit aperture 602 are indicated. In comparison with the electron simulation results shown in FIG. 6A, the motion of electrons in FIG. 6B shows a spray of electrons away from the center axis 244 and towards the bore of the ionization chamber and portions of the end wall 234 that are distant from the ion exit aperture located at the center axis 244. Within the volume adjacent to the ferromagnetic element 242, electron motion is not confined to spiral about the dominant direction of the magnetic field lines, and the electrons are more free to move along trajectories that are not parallel to the center axis 244. In effect, the ferromagnetic element 242 acts as a shield against the magnetic field produced by the magnetic field generator 240.

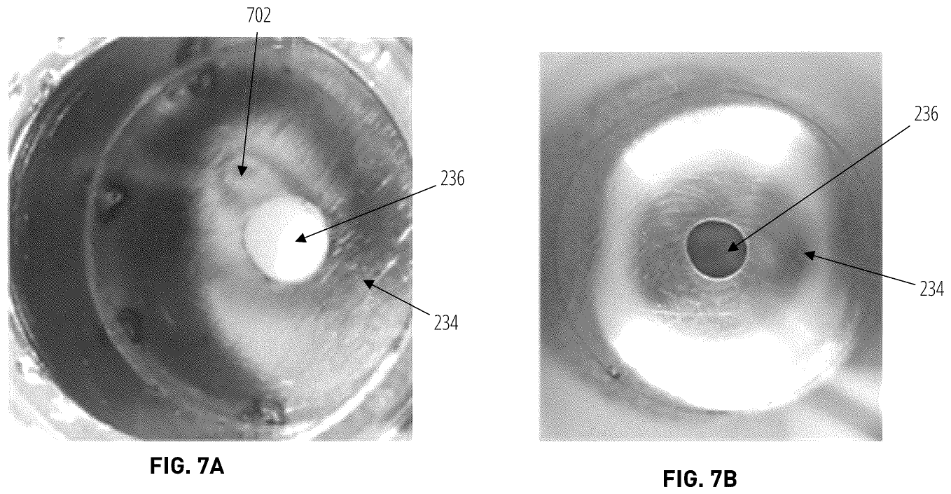

FIG. 7A is a photograph of the filament-side face of the ion exit aperture 236 and end wall 234 from a conventional system include only paramagnetic elements. With electrostatic potentials set to transmit analyte anions during negative CI analysis, most of the electrons either pass through the ion exit aperture or collide with the filament-side face of the end wall near the ion exit aperture of the ion source. The high density of electron collisions near the exit aperture increases the rate at which a dielectric layer is produced on a surface of the filament-side face causing charging and repulsion of analyte anions. As such, the proportion of analyte anions that transmit out the ion exit aperture to the detector is reduced. It is also not ideal for the electrons to exit the source because they may collide with other surfaces (and eventually cause charging) that are not as easily cleaned or not designed to be cleaned regularly. Both may contribute to lack of robustness in negative CI analysis.

The intense, localized burn 702 seen in FIG. 7A is asymmetric due to the asymmetric nature of the thermionic emitter in this particular embodiment. The person of ordinary skill in the art would appreciate that certain systems may produce a more symmetrical burn pattern or a less symmetrical burn pattern than that shown in FIG. 7A. The thermionic emitter in this case is an asymmetric filament that produces a larger flux of electrons through some portions of the entrance aperture 246 in the electron lens 204 than through other portions. Burns 702 are caused when electrons have sufficient energy to interact with species on a surface within the ion source to cause a dielectric layer to form. The dielectric layer can then positionally accumulate further electrons as they cannot be readily drawn away to ground due to the low conductivity of the dielectric layer. Burns 702 located on the end wall 234 proximate to the ion exit aperture 236 present a particular difficulty as the negative surface charge produced by accumulated electrons can repel analyte anions that are attempting to exit through the ion exit aperture. Removal of burns 702 requires cleaning at shorter intervals (resulting in more frequent instrument downtime), and the cleaning process is more involved for intense burns. Offset burns (for example, caused by source asymmetries) present a particularly difficult case as the burn tends to be concentrated rather than dispersed. Concentration of the electrons at the end wall near the ion exit aperture can increase burn intensity faster and more severely repel the desirable analyte anions from the stream. As will be described below, improved systems and methods taught herein can reduce the severity of burns.

FIG. 7B is a photograph of the filament-side face of the ion exit aperture 236 and end wall 234 from an ion source including both paramagnetic elements and ferromagnetic elements 242 as taught herein. The end wall 234 pictured in FIG. 7B was operated under similar working conditions and injected samples as the workpiece pictured in FIG. 7A. Intensity of the burn is significantly reduced in this sample as compared to that in FIG. 7A, and the burn is not clearly localized at one or a few discrete locations.

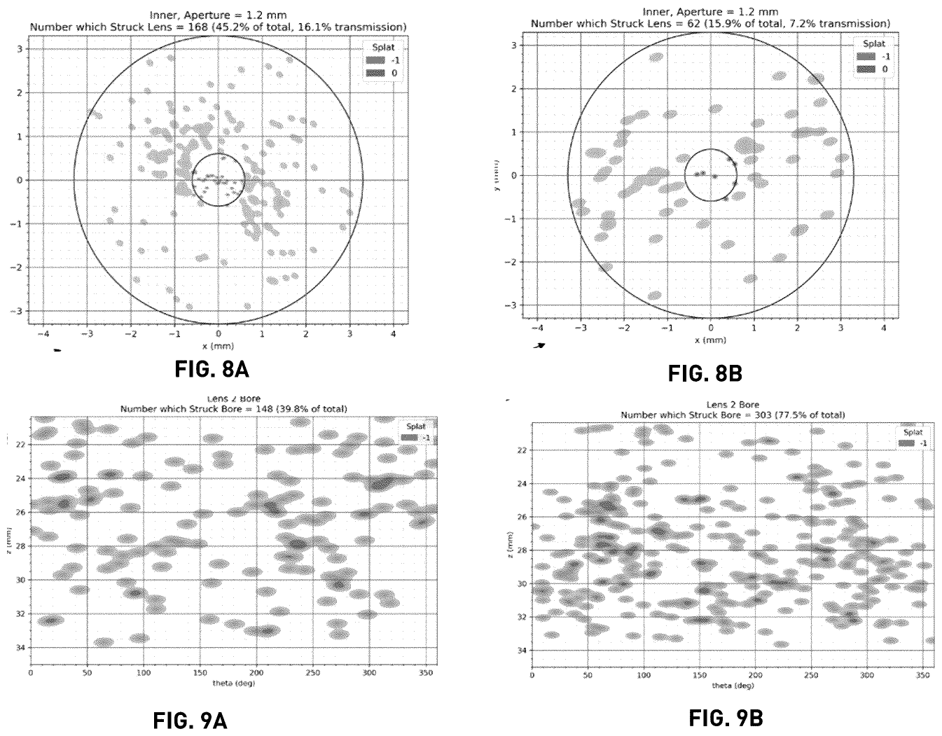

FIG. 8A illustrates a simulated x-y plot of the distribution of electron locations in the plane of the ion exit aperture 602 for the conventional source with only paramagnetic components. The area between the black circles represents the end wall 234 while the area within the inner black circle represents the ion exit aperture. The ion exit aperture has a diameter of 1.2 mm in this example. In this simulation, electrons were launched from the thermionic emitter. Then data from a population of electrons within a few millimeters distance from the lens was collected. About 45.2% of that population of electrons struck the end wall 234 and an additional 16.1% of the population of electrons passed through the ion exit aperture.

FIG. 8B illustrates a simulated x-y plot of the distribution of electron locations in the plane of the ion exit aperture 602 for the ion source with a combination of paramagnetic components and ferromagnetic elements 242. The area between the black circles represents the end wall 234 while the area within the inner black circle represents the ion exit aperture. The ion exit aperture has a diameter of 1.2 mm in this example. In this simulation, about 15.9% of the electron population within a few millimeters distance from the lens struck the end wall 234 and an additional 7.2% of the electrons passed through the ion exit aperture. The number of electrons hitting the end wall or passing through the exit aperture is greatly reduced from the number in FIG. 8A. In addition, the distribution of electron locations on the end wall 234 is more dispersed than in FIG. 8A, i.e., there is no concentration of electron locations close to the ion exit aperture as seen in FIG. 8A.

FIG. 9A illustrates a simulated z-0 plot of the distribution of electron locations along the inner surface 604 (i.e., bore) of the ionization chamber. In this simulation, about 39.8% of the electrons struck the inner surface of the ionization chamber.

FIG. 9B illustrates a simulated z-0 plot of the distribution of electron locations along the inner surface 604 (i.e., bore) of the ionization chamber for an ion source having a combination of paramagnetic elements and ferromagnetic elements 242. In this simulation, about 77.5% of the electrons struck the inner surface (bore) of the ionization chamber. This number is a marked increase over the number that struck the inner surface of the ionization chamber in the comparison experiment illustrated in FIG. 9A.

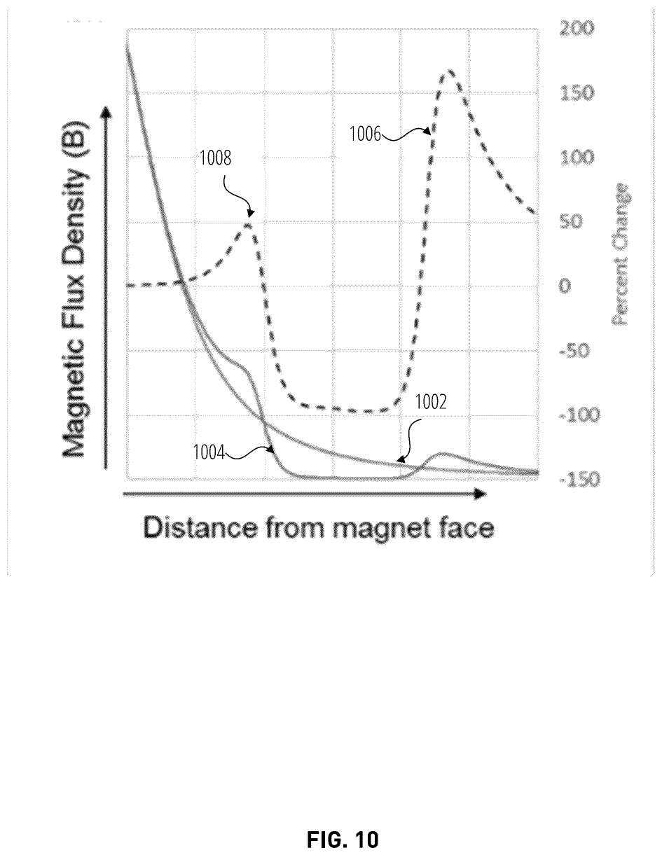

In embodiments described above, the introduction of ferromagnetic elements 242 enabled a reduction in the number of electrons that pass through or near the ion exit aperture 236 and reduced fouling of the end wall 234. Ferromagnetic elements as described herein can also be employed to achieve other advantages. In some embodiments, an electron lens including an entrance aperture separates the electron source from the ionization chamber. As described below in relation to FIG. 10-FIG. 14B, the use of ferromagnetic elements within or adjacent to the ionization chamber can improve flux of electrons into the ionization chamber 206 through the entrance aperture 246 of the electron lens 204.

FIG. 10 shows several plots related to magnetic field along the center axis as a function of distance from the magnetic field generator 240 for a variety of sources. Curve 1002 represents the magnetic flux density as a function of distance for a conventional ion source including only paramagnetic materials. Curve 1002 shows a monotonic decrease in magnetic flux density within the ionization volume from one end of the ionization chamber to the other end. Curve 1004 represents the magnetic flux density as a function of distance for an ion source that includes ferromagnetic elements to create improved electron throughput through the entrance aperture of the electron lens in accordance with certain embodiments described herein. Curve 1004 shows the non-monotonic change of magnetic flux density within the ionization volume as a function of distance along the ionization chamber (e.g., distance from the magnetic field generator). Curve 1006 represents the percentage change in magnetic flux density value for curve 1004 as compared to curve 1002. One useful property of the ferromagnetic element is that the magnetic flux density sharply increases at localized positions to the anterior and posterior of the ferromagnetic element. Curve 1006 illustrates such an increase 1008 in magnetic field density, and this increase 1008 can be spatially located in the proximity of the electron lens in some embodiments. By tailoring the proximity of the ferromagnetic section 250 (following an anterior paramagnetic section 248) to the electron lens 204, the magnetic flux density through an entrance aperture 246 of the electron lens 204 can be increased. Such an increase in magnetic field will tighten the radius of the electron beam passing through the aperture (i.e., confine the electrons more closely to the center axis 244). The tightening of the beam of electrons can reduce burning and charging near the entrance aperture 246 of the electron lens 204 and increase the flux of electrons through the entrance aperture 246. In some embodiments, the electron lens 204 can be separated from the ferromagnetic element 242 by a distance such that the position of peak magnetic flux density anterior to the ferromagnetic element 242 overlaps with the position of the electron lens 204.

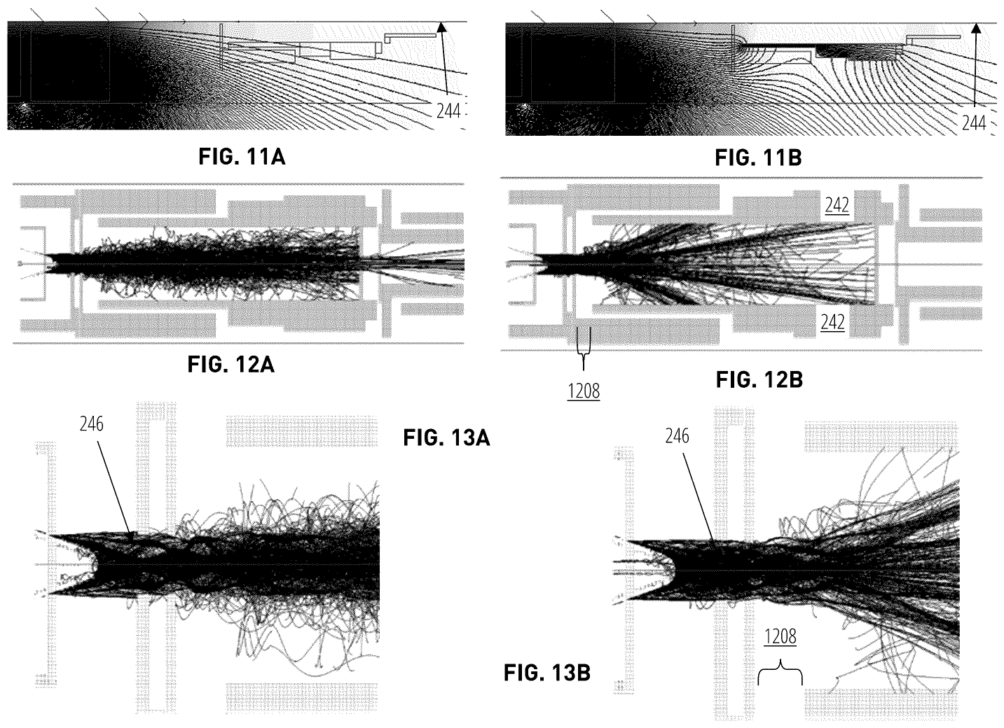

FIG. 11A illustrates a simulation of magnetic field lines for an ion source including only paramagnetic components. The same simulation parameters and constraints were used in this simulation as described above with respect to FIG. 5A and FIG. 5B. The magnetic field lines begin at the front face of the magnetic field generator 240 as shown and circle around to end at the opposite face. The field lines pass through components of the ion source with little to no diversion or bending. Additionally, field strength as represented by the background shading in FIG. 11A is uniform throughout the components of the ion source and shows no concentration within or near any components of the ion source.

FIG. 11B illustrates a simulation of magnetic field lines and magnetic field strength in the ion source 102, 200 that includes a combination of paramagnetic and ferromagnetic elements in accordance with various embodiments described herein. The field lines are deviated in this figure as compared to FIG. 11A particularly in the vicinity of the entrance aperture 246. Moreover, the field strength in the ferromagnetic elements 242 of the ion source is retained to a greater degree than in the same elements of FIG. 11A formed from paramagnetic material.

FIG. 12A illustrates a simulation of electron trajectories within the conventional ion source having primarily or only paramagnetic components, and FIG. 13A illustrates a magnified portion of the image in FIG. 12A. The plots in FIG. 12A-FIG. 13B were generated using the same parameters as described above with respect to FIG. 6A and FIG. 6B. While the electrons are confined to some degree to the center axis 244 along the entire length of the ion source in FIG. 12A, the confinement is not particularly tight in the vicinity of the entrance aperture. As with the simulation in FIG. 6A, the confinement of the electrons to the center axis 244 creates space charge issues and allows electrons to escape through the ion exit aperture. As seen in the magnified view of FIG. 13A, several electron trajectories terminate on the wall of the entrance aperture and a lower density of electron trajectories near the center axis is observable.

FIG. 12B illustrates a simulation of electron trajectories within the ion source as taught herein where a ferromagnetic element 242 is located in the vicinity of the electron lens, and FIG. 13B shows a magnified portion of the image in FIG. 12B. The ferromagnetic element 242 is offset from the electron lens by a distance 1208. In various embodiments, the distance 1208 between the electron lens 204 and the ferromagnetic element can be in a range from 0.1 mm to 0.5 mm, 0.25 mm to 1.0 mm, 0.5 mm to 1 mm, 0.75 mm to 2 mm, 1 mm to 10 mm, 5 mm to 20 mm, 10 mm to 50 mm, 0.1 mm to 50 mm, or any suitable distance to locate the local peak magnetic flux density at the appropriate position near or on the electron lens 204. In some embodiments, the distance 1208 can be the position in front of the ferromagnetic element where the concentration of magnetic field lines entering the ferromagnetic element creates a peak in magnetic field density. As evidenced by the darkness caused by overlapping paths through the entrance aperture in FIG. 13B, the electrons are better confined to the center axis and a greater number of electrons pass through the entrance aperture. The greater confinement of the electrons arises because magnetic field lines coalesce or concentrate strongly to create an increased magnetic field localized at the distance 1208 away from the end of the ferromagnetic element 242. Note that the differences in the ion trajectories between FIG. 12A and FIG. 12B can be ascribed to the change in material type of the structures (i.e., the change from paramagnetic to ferromagnetic for the ferromagnetic element 242) because there is no change in the shape of the structure in the ionization chamber.

In other embodiments, the ferromagnetic element 242 can be placed in the vicinity or proximity of the source filament such as the thermionic emitter 226 at the distance 1208 anterior to the electron lens 204. This configuration differs from the configuration described above and shown in FIGS. 12B and 13B in that the ferromagnetic element 242 is located at the distance 1208 posterior to the electron lens 204. Because the magnetic field lines are also concentrated strongly to the posterior (or exit) of ferromagnetic element 141 (see FIG. 10), the magnetic flux density also experiences a local peak intensity at the distance 1208 posterior to an end of the ferromagnetic element 242. Placement of the ferromagnetic element 242 anterior to the electron lens 204 by the distance 1208 can increase magnetic field density through the entrance aperture 246, which confines the electrons to the center axis 244 more tightly at the entrance aperture 246. This confinement reduces electron collisions near the entrance aperture 246 and increases the flux of electrons through the entrance aperture 246 and into the ionization chamber.

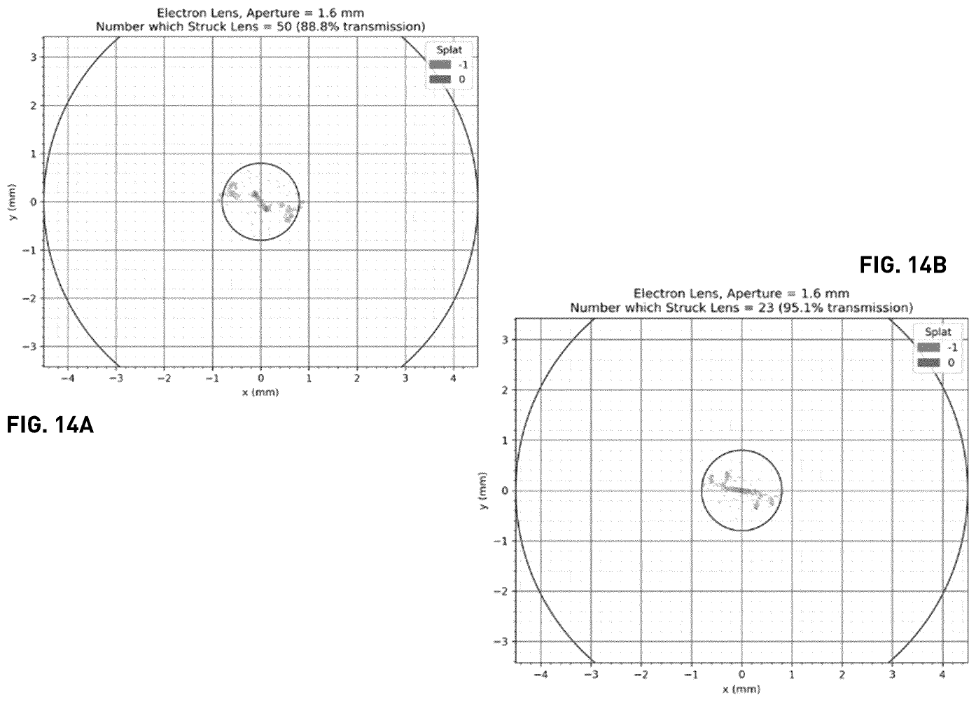

FIG. 14A illustrates a simulated x-y plot of the distribution of electron locations in the plane of the entrance aperture for the conventional source with only paramagnetic components. The area between the black circles represents the electron lens while the area within the inner black circle represents the entrance aperture. The entrance aperture has a diameter of about 1.6 mm in this example. In this simulation, about 88.8% of the electron population within a few millimeters distance from the lens pass through the entrance aperture and enter the ionization chamber. Similar to FIG. 6A, the electrons still have a relatively large number of collisions with the end wall near the ion exit aperture.

FIG. 14B illustrates a simulated x-y plot of the distribution of electron locations in the plane of the entrance aperture for the ion source with a combination of paramagnetic components and ferromagnetic elements 242. The area between the black circles represents the electron lens while the area within the inner black circle represents the entrance aperture. The entrance aperture has a diameter of about 1.6 mm in this example. In this simulation, about 95.1% of the electron population within a few millimeters distance from the lens pass through the entrance aperture and enter the ionization chamber. Thus, the use of a ferromagnetic element 242 to increase the magnetic field in the vicinity of the entrance aperture increase the flux of electrons into the ionization chamber. A greater flux of electrons creates greater efficiency in ionization of the analyte molecules for the same power level in the thermionic emitter.

In some embodiments, ion sources including ferromagnetic elements as taught in embodiments described herein can also reduce the number of reflected electrons that return from outside the ionization chamber and strike the end wall. Such an embodiment is particularly useful for ion sources that are used in particular electron ionization (EI) mode configurations wherein the electron reflections are utilized to increase the chance of ionization events in the ionization volume. In this mode, the final tube lens beyond the ion exit aperture and external to the ionization chamber has voltages set to repel electrons to cause at least some of the electrons to reflect back into the ionization chamber where they have further opportunities to interact with the analyte species. In a conventional ion source operating in EI mode, a high population of reflected electrons can collide with an exit face (i.e., the face opposite the thermionic emitter). Conversely, in embodiments of ion sources taught herein, the ferromagnetic element can be placed at a distance from the end wall (e.g., as a final tube lens) to increase the magnetic field density at the ion exit aperture of the end wall. As a result, fewer electrons collide with the end wall and electron reflection efficiency (i.e., percentage of back-traveling electrons that re-enter the ionization chamber through the ion exit aperture) is increased.

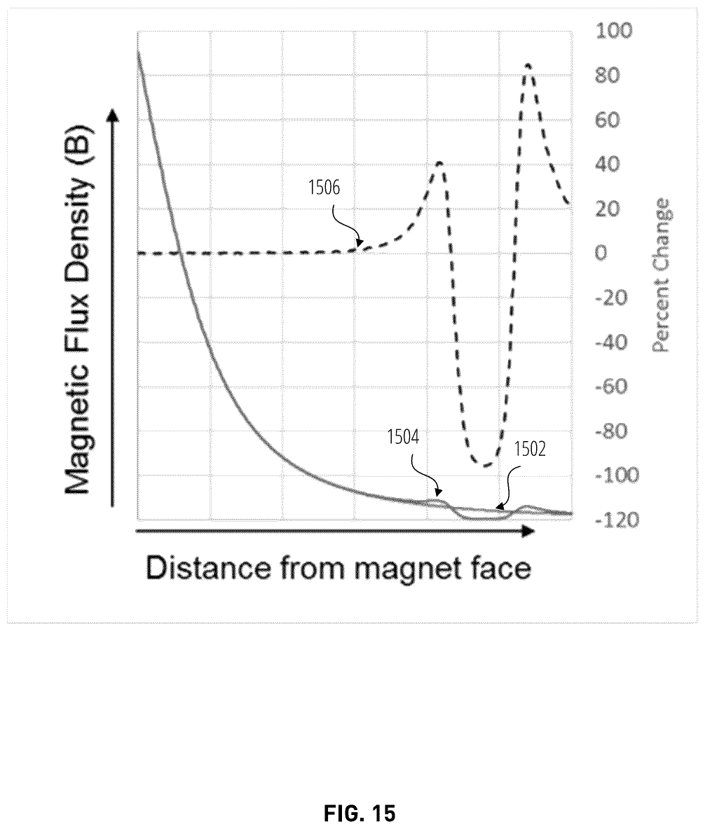

FIG. 15 shows several curves related to magnetic flux density along the center axis as a function of distance from the magnetic field generator 240 for a variety of sources. Curve 1502 represents the magnetic flux density as a function of distance for a conventional ion source including only paramagnetic materials. The curve 1502 shows flux density decreasing monotonically as a function of distance from one end of the ionization chamber to the other. Curve 1504 represents the magnetic flux density as a function of distance for an ion source that includes ferromagnetic elements to prevent reflected electrons from hitting an exit face (i.e., the face opposite the thermionic emitter) of the end wall 234 in accordance with some embodiments taught herein. The curve 1504 shows non-monotonic changes (i.e., both increases and decreases) in magnetic flux density from one end of the ionization chamber to the other (e.g., as a function of distance from the magnetic field generator 240). Curve 1506 represents the percentage change in magnetic flux density value for curve 1502 as compared to curve 1504. In this embodiment, the location of the ferromagnetic element is selected to create a high magnetic field density at or just beyond the end wall 234 to confine electrons to the center axis 244 and prevent reflected electrons from striking the exit face of the end wall, which causes charge buildup and fouling/burning of the surface of the end wall.

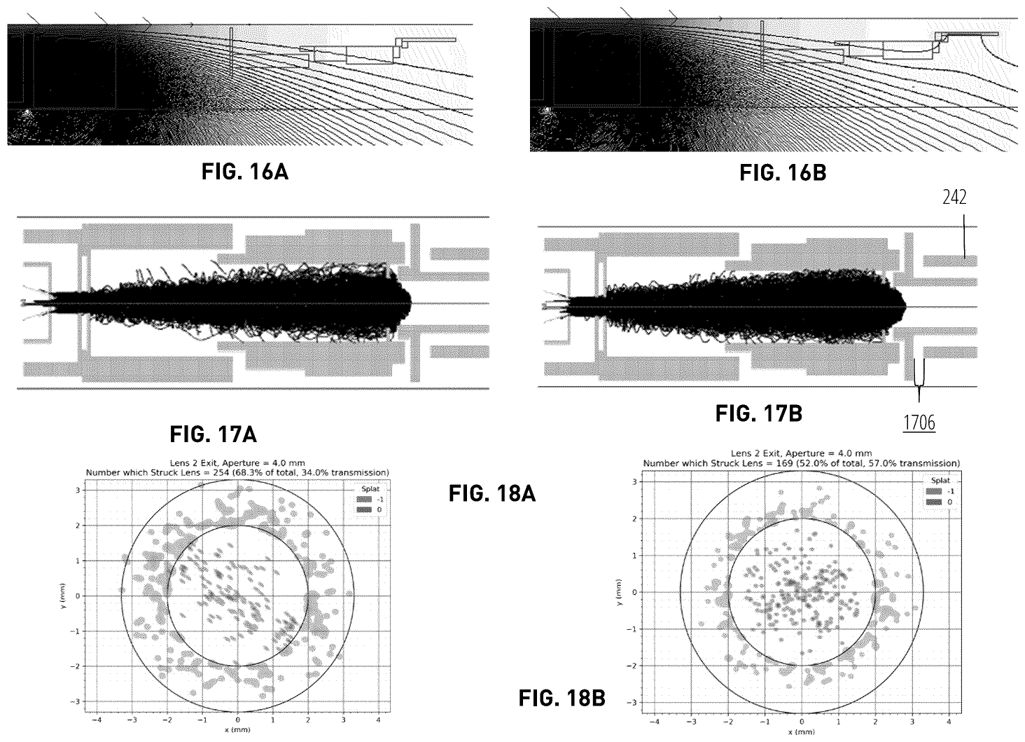

FIG. 16A illustrates a simulation of magnetic field lines for an ion source including only paramagnetic components. The magnetic field lines begin at the front face of the magnetic field generator 240 as shown and circle around to end at the opposite face. The field lines pass through components of the ion source with little to no diversion or bending. Additionally, field strength as represented by the background shading in FIG. 16A is uniform throughout the components of the ion source and shows no concentration within or near any components of the ion source.

FIG. 16B illustrates a simulation of magnetic field lines and magnetic field strength in the ion source 102, 200 that includes a combination of paramagnetic and ferromagnetic elements in accordance with various embodiments described herein. In particular, the ferromagnetic element is part of a tube lens that is located along the center axis and adjacent to the end wall of the ionization chamber. The field strength in the ferromagnetic elements 242 of the ion source is retained to a greater degree than in the same elements of FIG. 16A formed from paramagnetic material.

FIG. 17A illustrates a simulation of electron trajectories within the conventional ion source having primarily or only paramagnetic components. In these simulations, the pressure is reduced and the electrostatic potentials on components are set to be in an EI mode with the final tube lens set to repel electrons. As electrons are reflected by the tube lens back towards the ionization chamber, the electron trajectories are not well confined to the center axis and impact the exit surface of the end wall 234.

FIG. 17B illustrates a simulation of electron trajectories within the ion source as taught herein where the ferromagnetic element 242 is placed in or near the tube lens at a distance 1706 away from the end wall 234 along the center axis. In various embodiments, the distance 1706 between the end wall 234 and the ferromagnetic element can be in a range from 0.1 mm to 0.5 mm, 0.25 mm to 1.0 mm, 0.5 mm to 1 mm, 0.75 mm to 2 mm, 1 mm to 10 mm, 5 mm to 20 mm, 10 mm to 50 mm, 0.1 mm to 50 mm, or any suitable distance to locate the local peak magnetic flux density at the appropriate position near or on the end wall 234. Because electrons are reflected by the negative potentials applied in the tube lens, they turn around to re-enter the ionization chamber. The ferromagnetic element 242 produces a peak in magnetic flux density at the distance 1706 (i.e., at the end wall) to confine the electron trajectories to near the center axis 244 such that fewer electrons strike the exit surface of the end wall 234. The greater confinement of the electrons arises because magnetic field lines coalesce and concentrate strongly to create an increased magnetic field near the end of the ferromagnetic element 242.

FIG. 18A illustrates a simulated x-y plot of the distribution of electron locations in the plane of the ion exit aperture for the conventional source with only paramagnetic components. The area between the black circles represents the exit face of the end wall 234 while the area within the inner black circle represents the ion exit aperture. The ion exit aperture has a diameter of 4.0 mm in this example.

FIG. 18B illustrates a simulated x-y plot of the distribution of reflected electron locations on the exit face (i.e., the face opposite the electron source) of the ion exit aperture. The increase in magnetic field density near the ion exit aperture is increased, which increases the confinement of the electrons near the center axis. As a result, fewer electrons collide with the end wall of the source. In comparison to FIG. 18A, fewer electrons strike the end wall while more electrons pass through the ion exit aperture and back into the ionization chamber. In this simulation, the number of electrons that struck the end wall was reduced by 33% when ferromagnetic materials were used as compared to paramagnetic-only sources (52.0% versus 68.3% of electrons strike the lens). Similarly, the embodiment including ferromagnetic elements improves signal in analyte detection due to the increased electron reflection efficiency (which increases opportunities for ionization of the analytes). Finally, the ion source taught herein has increased robustness because the intensity of the burn generated near the ion exit aperture by reflected electrons is reduced.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as a limitation on the claims. In addition, claims directed to a method and/or process should not be limited to the performance of their steps in the order written, and one skilled in the art can readily appreciate that the sequences may be varied and still remain within the spirit and scope of the various embodiments.

The embodiments described herein can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms such as producing, identifying, determining, or comparing.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

What is claimed is:

1. An ion source, comprising:
an electron source configured to produce electrons;
an ionization chamber having an entrance aperture through an electron lens, an ion exit aperture through an end wall, and a center axis through an ionization volume within the ionization chamber, the ionization chamber configured to produce ions; and
a ferromagnetic element disposed proximate to the ionization volume such that the electrons are confined to the center axis within a paramagnetic section of the ionization volume and the electrons diverge away from the center axis within a ferromagnetic section of the ionization volume.

2. The ion source of claim 1, further comprising a magnetic field generator proximate to an end of the ion source closest to the electron source.

3. The ion source of claim 1, wherein the paramagnetic section includes a high-density electron region where the electrons interact with neutral molecules introduced through a gas inlet to form analyte ions or reagent ions.

4. The ion source of claim 1, further comprising a second paramagnetic section disposed after the ferromagnetic section along the center axis.

5. The ion source of claim 1, wherein the ferromagnetic element includes the end wall.

6. The ion source of claim 1, wherein the ferromagnetic element is disposed within the ionization chamber.

7. The ion source of claim 1, wherein the ferromagnetic element is attached to or embedded within a portion of an outer wall of the ionization chamber.

8. The ion source of claim 1, wherein the ferromagnetic element is disposed externally to the ionization chamber.

9. The ion source of claim 1, wherein the ferromagnetic element is configured to be moved to adjust the location of the ferromagnetic section within the ionization volume.

10. The ion source of claim 1, wherein the ferromagnetic element generates non-monotonic changes in a magnetic field along the center axis from the entrance aperture to the ion exit aperture.

11. A method of operating an ion source, comprising:
generating a magnetic field in an ionization volume of an ionization chamber of the ion source using a magnetic field generator;
passing electrons through a paramagnetic section of the ionization volume wherein the magnetic field confines the electrons to a center axis of the ionization volume; and
passing the electrons through a ferromagnetic section of the ionization volume generated by a ferromagnetic element disposed within or adjacent to the ionization chamber, the electrons diverging away from the center axis within the ferromagnetic section of the ionization volume.

12. The method of claim 11, further comprising introducing neutral molecules into the ionization chamber through a gas inlet, and
wherein passing the electrons through the paramagnetic section includes interacting the electrons with the neutral molecules in a high-density electron region in the paramagnetic section to form analyte ions or reagent ions.

13. The method of claim 11, further comprising passing ions through the ferromagnetic section of the ionization volume to spatially separate the ions and the electrons.

14. The method of claim 11, wherein the ferromagnetic element is disposed within the ionization chamber.

15. The method of claim 11, wherein the ferromagnetic element is attached to the ionization chamber or the ferromagnetic element is embedded within a portion of an outer wall of the ionization chamber.

16. The method of claim 11, wherein the ferromagnetic element is disposed external to the ionization chamber.

17. An ion source, comprising:
an electron source configured to produce electrons;
an ionization chamber having an entrance aperture through an electron lens, an ion exit aperture through an end wall, and a center axis through an ionization volume within the ionization chamber, the ionization chamber configured to produce ions; and
a ferromagnetic element at a distance from the end wall or the electron lens such that magnetic field lines are concentrated at the ion exit aperture or the entrance aperture, respectively.

18. The ion source of claim 17, wherein the distance is a length of a paramagnetic section in the ionization volume.

19. The ion source of claim 17, wherein the ferromagnetic element comprises a final tube lens disposed posterior to the end wall along the center axis.

20. The ion source of claim 17, wherein a surface of the ferromagnetic element is protected by a paramagnetic insert or by a coating from interacting chemically with the electrons or ions.
